(19) United States
(12) Patent Application Publication
(10) Pub. No.: US 2018/0150268 A1
(43) Pub. Date: May 31, 2018

(54) IMAGE FORMING APPARATUS AND METHOD FOR INSTALLING PRINTER DRIVER IN HOST DEVICE

(71) Applicant: S-Printing Solution Co., Ltd., Suwon-si (KR)

(72) Inventor: Hyoung-dong CHOI, Hwaseong-si (KR)

(73) Assignee: S-Printing Solution Co., Ltd., Suwon-si (KR)

(21) Appl. No.: 15/706,953

(22) Filed: Sep. 18, 2017

(30) Foreign Application Priority Data
Nov. 28, 2016 (KR) 10-2016-0159421

(51) Int. Cl. G06F 3/12; G06F 3/038; G06F 3/06

(52) U.S. Cl. CPC G06F 3/1225; G06F 2003/0697; G06F 3/06; G06F 3/038

(57) ABSTRACT

An image forming apparatus and a method of installing a printer driver in a host device includes: transmitting an agent program to the at least one host device; receiving printer driver installation information of the at least one host device from the agent program; displaying the printer driver installation information; receiving, from a user, an input of selecting a host device in which to install or update the printer driver; and transmitting the printer driver to the selected host device.

### CROSS-REFERENCE TO RELATED APPLICATIONS

This application claims the benefit of Korean Patent Application No. 10-2016-0159421, filed on Nov. 28, 2016, in the Korean Intellectual Property Office, the disclosure of which is incorporated herein in its entirety by reference.

### BACKGROUND

### 1. Field

The present disclosure relates to an image forming apparatus and method for installing a printer driver in a host device, and more particularly to, an image forming apparatus and method for installing or updating a printer driver in a selected host device.

### 2. Description of the Related Art

Today, most companies are building network systems within their organizations for efficient business operations. A network system (e.g., a B2B network or a managed printing solution (MPS)) established within such a company may allow a printer to print content by transmitting the content from a plurality of computers to the printer.

However, in order to use a printer, a printer driver must be installed in each of a plurality of computers connected to a network system. It is troublesome to manage printer drivers individually in a plurality of computers, and there is a problem in that it requires time and effort of computer users.

### SUMMARY

Provided are an image forming apparatus and method for installing a printer driver in a host device.

Additional aspects will be set forth in part in the description which follows and, in part, will be apparent from the description, or may be learned by practice of the presented embodiments.

According to an aspect of an embodiment, a method, performed by an image forming apparatus, of installing the printer driver in at least one host device includes: transmitting an agent program to the at least one host device; receiving printer driver installation information of the at least one host device from the agent program; displaying the printer driver installation information; receiving, from a user, an input of selecting a host device in which to install or update the printer driver; and transmitting the printer driver to the selected host device.

According to an aspect of another embodiment, an image forming apparatus includes an input/output unit configured to receive a user input and display printer driver installation information; a communicator configured to transmit data to at least one host device; and a controller configured to receive an input of selecting a host device in which to install or update a printer driver from a user through the input/output unit, transmit an agent program to the at least one host device through the communicator, receive the printer driver installation information of the at least one host device from the agent program, and transmit the printer driver to the at least one host device.

According to an aspect of another embodiment, there is a non-transitory computer-readable recording medium having recorded thereon a program for executing the method by using a computer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram showing an example in which an image forming apparatus according to an embodiment manages a printer driver of a host device;

FIG. 2 is a block diagram of an image forming apparatus according to an embodiment;

FIG. 3 is a diagram of configurations of an image forming apparatus and a host device according to an embodiment;

FIG. 4 is a flowchart of a method of installing and updating a printer driver in a host device through an agent program performed by an image forming apparatus according to an embodiment;

FIG. 5 is a flowchart of a method in which a host device according to an embodiment installs and updates a printer driver by an image forming apparatus;

FIG. 6 is a diagram illustrating a process of installing or updating a printer driver according to an embodiment;

FIG. 7 is a diagram showing an example in which an image forming apparatus searches for a host device according to an embodiment;

FIG. 8 is a diagram showing an example in which an image forming apparatus according to the embodiment receives identification information of a host device;

FIG. 9 is a diagram showing an example in which an image forming apparatus according to an embodiment receives printer driver installation information of a host device;

FIG. 10 is a diagram showing an example in an image forming apparatus according to an embodiment installs a printer driver in a selected host device; and

FIG. 11 is a diagram illustrating an example in which an image forming apparatus according to an embodiment selects a host device to install an agent program.

### DETAILED DESCRIPTION

Reference will now be made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted here.

In the specification, when an element is “connected” to another element, the elements may not only be “directly connected”, but may also be “electrically connected” via another element therebetween. Also, when a region “includes” an element, the region may further include another element instead of excluding the other element, unless otherwise differently stated.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Also, an “image forming apparatus” may denote any apparatus capable of performing an image forming job, such as a printer, a scanner, a fax machine, a multi-function printer (MFP), or a display apparatus.

Also, a “hard copy” may denote an operation of printing an image on a print medium, such as a paper, and a “soft copy” may denote an operation of printing an image on a display device, such as a television (TV) or a monitor.

Also, “content” may denote any type of data that is a target of an image forming job, such as a picture, an image, or a document file.

Also, “print data” may denote data having a format printable by a printer.

Also, a “scan file” may denote a file generated by scanning an image by using a scanner.

Also, a “user” may denote a person who performs manipulation related to an image forming job by using an image forming apparatus or a device connected to the image forming apparatus wirelessly or via wires. Also, a “manager” may denote a person who has authority to access all functions and a system of an image forming apparatus. A “manager” and a “user” may be the same person.

A method of diagnosing a fax function of an image forming apparatus, and an apparatus for performing the method will now be described in detail with reference to the drawings. The fax function may be diagnosed by a diagnosis server. For example, an image forming apparatus having a fax function may be used as the diagnosis server, and a program for diagnosing the fax function may be installed in the image forming apparatus used as the diagnosis server.

Alternatively, the diagnosis server may be embedded in the image forming apparatus subject to diagnosis.

The diagnosis server may receive a diagnosis request to diagnose the fax function, from a mobile device of a user or a service engineer via an email. Alternatively, the diagnosis server may receive the diagnosis request via a diagnosis application executed in the mobile device of the user or the service engineer. Otherwise, when the image forming apparatus subject to diagnosis is used as the diagnosis server, the diagnosis server may directly receive the diagnosis request from the user.

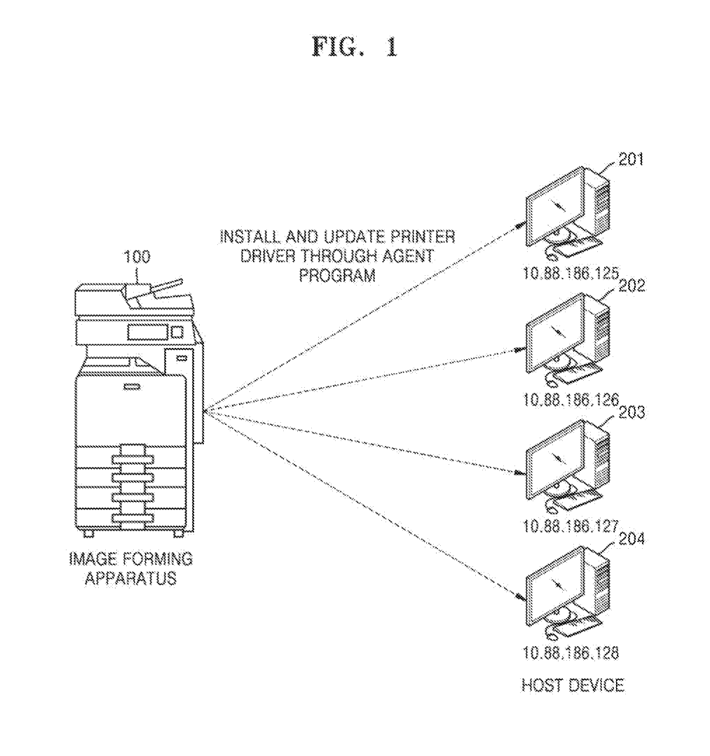

FIG. 1 is a diagram showing an example in which an image forming apparatus 100 according to an embodiment manages a printer driver of a host device.

Referring to FIG. 1, the image forming apparatus 100 may install and update a printer driver in host devices 201 to 204 through an agent program installed in the host devices 201 to 204.

The agent program may be a software configuration that performs operations necessary for installing and updating a printer driver. A detailed operation performed by the agent program will be described in the following embodiments.

The agent program may search for a memory of the host devices 201 to 204 to generate installation information of the printer driver and transmit the generated installation information of the printer driver to the image forming apparatus 100. The installation information of the printer driver generated by the agent program may be information on whether a printer driver is installed in a host device or version information of the printer driver installed in the host device.

The agent program may also install or update the printer driver received by the host devices 201 to 204. The agent program may execute or store the printer driver received by the host devices 201 to 204 in the host devices 201 to 204.

The image forming apparatus 100 may efficiently manage the printer drivers of the plurality of host devices 201 to 204 by using the agent program. Also, the image forming apparatus 100 may collectively install the printer drivers in the plurality of host devices 201 to 204, or may install the printer driver only some of the plurality of host devices 201 to 204 selected according to an external input.

Also, the image forming apparatus 100 may execute the agent program only on the host device selected by a user from the plurality of host devices 201 to 204. Also, the image forming apparatus 100 may install a printer driver of a specific version selected by the user in the host devices 201 to 204.

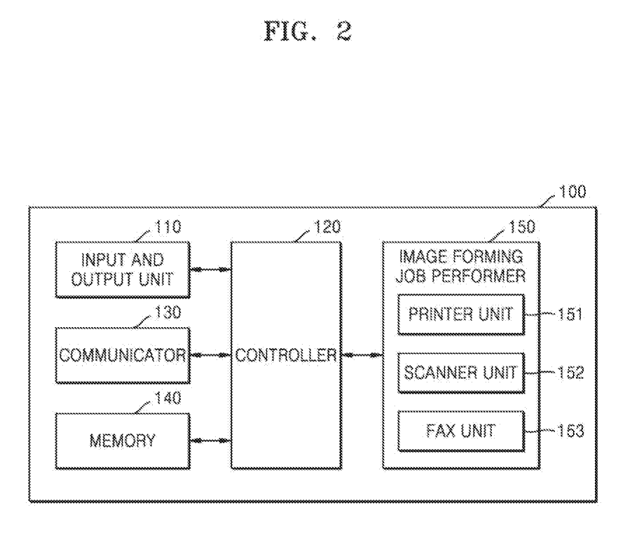

FIG. 2 is a block diagram of an image forming apparatus 100 according to an embodiment. Referring to FIG. 2, the image forming apparatus 100 according to an embodiment may include an input and output unit 110, a controller 120, a communicator 130, a memory 140, and an image forming job performer 150. Also, although not illustrated in FIG. 2, the image forming apparatus 100 may further include a power supplier for supplying power to each component of the image forming apparatus 100.

The input and output unit 110 may include an input unit for receiving, from a user, an input for performing an image forming job, and an output unit for displaying information, such as a result of performing an image forming job or a state of the image forming apparatus 100. For example, the input and output unit 110 may include an operation panel for receiving a user input and a display panel for displaying a screen.

In detail, the input unit may include at least one of devices for receiving various types of user inputs, such as a keyboard, a physical button, a touch screen, a camera, and a microphone. Also, the output unit may include, for example, a display panel or a speaker. However, an embodiment is not limited thereto, and the input and output unit 110 may include at least one device supporting various inputs and outputs.

The controller 120 controls overall operations of the image forming apparatus 100, and may include a processor, such as a central processing unit (CPU). The controller 120 may control other components included in the image forming apparatus 100 such that an operation corresponding to a user input received through the input and output unit 110 is performed.

For example, the controller 120 may execute a program stored in the memory 140, read a file stored in the memory 140, or store a new file in the memory 140.

The communicator 130 may communicate with another device or a network in a wired or wireless manner. Accordingly, the communicator 130 may include a communication module supporting at least one of various wired and wireless communication methods. For example, the communication module may be in a form of a chipset or may be a sticker or a barcode (for example, a sticker including a near field communication (NFC) tag) including information required for communication.

Wireless communication may include, for example, at least one of wireless fidelity (Wi-Fi), Wi-Fi direct, Bluetooth, ultra wideband (UWB), and NFC. Wired communication may include, for example, at least one of universal serial bus (USB) and high definition multimedia interface (HDMI).

The communicator 130 may be connected to an external apparatus 200 provided outside the image forming apparatus 100 to transmit and receive a signal or data to and from the external apparatus 200. Referring to FIG. 2, the image forming apparatus 100 is connected to the external apparatus 200 through the communicator 130. The communicator 130 may transmit a signal or data received from the external apparatus 200 to the controller 120, or transmit a signal or data generated by the controller 120 to the external apparatus 200. For example, when the communicator 130 receives a print command signal or print data from the external apparatus 200, the controller 120 may output the print data through a printer 151.

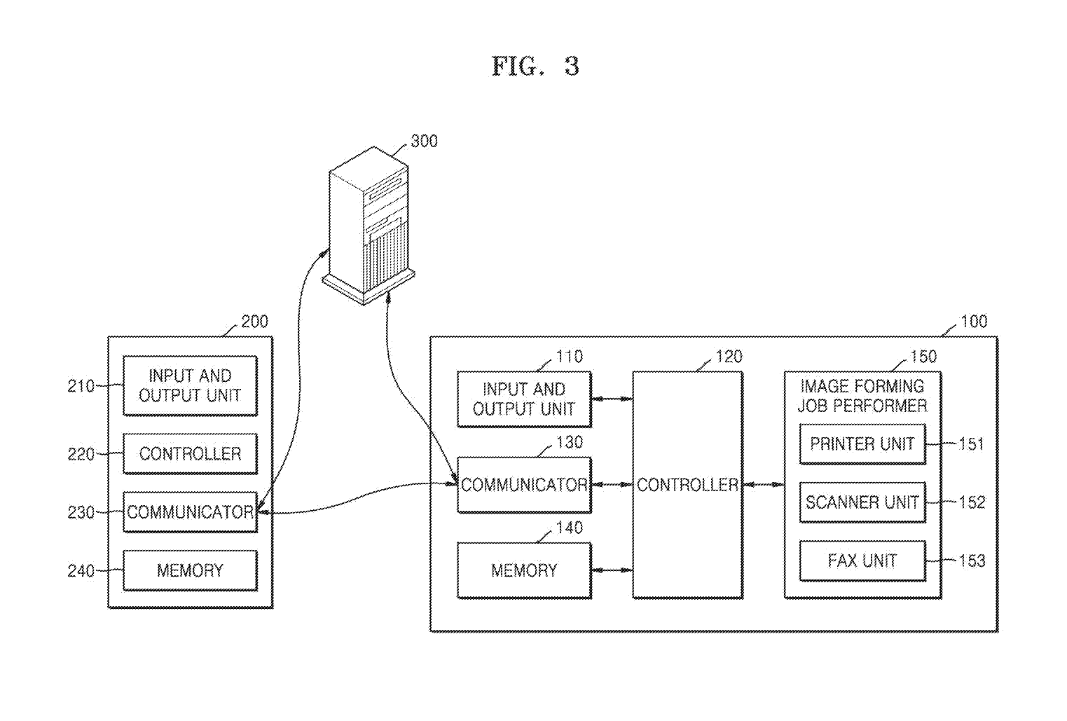

As shown in FIG. 3, the external apparatus 200 may include an input and output unit 210, a controller 220, a communicator 230, and a memory 240.

The controller 220 may control an image forming job by executing a program stored in the memory 240 and transmitting a signal or data generated as a result of executing the program to the image forming apparatus 100 through the communicator 230.

Referring back to FIG. 2, the various types of data, such as a file or a program like an application, may be installed and stored in the memory 140. The controller 120 may access the data stored in the memory 140 to use the data, or may store new data in the memory 140. Also, the controller 120 may execute the program installed in the memory 140. Also, the controller 120 may install an application received from an external source through the communicator 130 in the memory 140.

The image forming job performer 150 may perform an image forming job, such as printing, scanning, or faxing.

Referring to FIG. 2, the image forming job performer 150 includes the printer 151, a scanner 152, and a facsimile 153, but as occasion demands, the image forming job 150 may include some of them or may further include a component for performing another type of image forming job.

The printer 151 may form an image on a recording medium via any one of various printing methods, such as an electrophotography method, an inkjet method, a thermal transfer method, and a thermal method.

The scanner 152 may irradiate light onto paper and receive light reflected from the paper to read an image recorded on the paper. Examples of an image sensor for reading an image from paper include a charge-coupled device (CCD) and a contact type image sensor (CIS). The scanner 152 may have a flatbed structure in which paper is located at a fixed location and an image sensor moves to read an image, a document feed structure in which an image sensor is located at a fixed location and paper is transferred, or a combination structure thereof.

The facsimile 153 may share a component for scanning an image with the scanner 152, share a component for printing a received file with the printer 151, transmit a scan file to a destination, or receive a file from an external source.

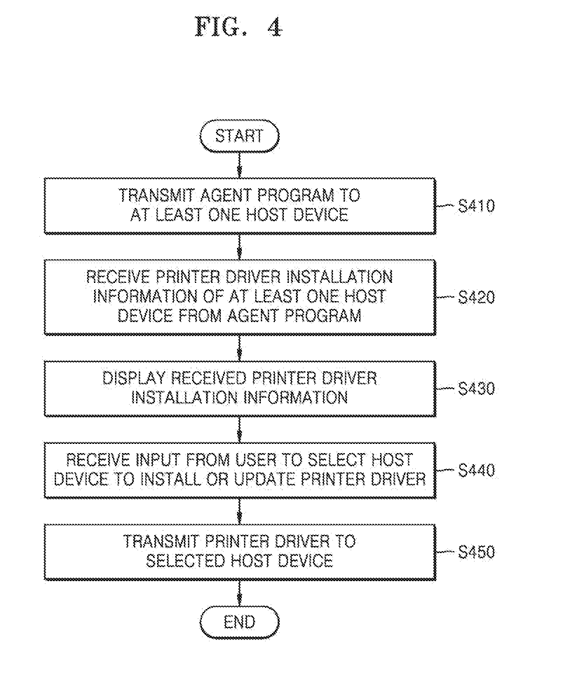

FIG. 4 is a flowchart of a method of installing and updating a printer driver in a host device through an agent program performed by an image forming apparatus according to an embodiment.

Referring to FIG. 4, in operation S410, the image forming apparatus 100 may transmit the agent program to at least one host device. In an embodiment, the image forming apparatus 100 may transmit the agent program to all connected host devices and transmit the agent program only to a host device selected according to an external input. Further, the image forming apparatus 100 may transmit the agent program to the host device selected by a user.

In an embodiment, the image forming apparatus 100 may transmit an agent program execution command transmitted to at least one host device. In an embodiment, the image forming apparatus 100 may allow the host device to execute the received agent program. Further, the image forming apparatus 100 may transmit a save command or an install command of the transmitted agent program. The host device may execute, store or install the agent program according to the received command.

In an embodiment, the image forming apparatus 100 may request printer driver installation information of the host device from the executed agent program. In an embodiment, the image forming apparatus 100 may request the installed agent program whether to install the printer driver of the host device, and request version information of the printer driver installed in the host device.

In operation S420, the image forming apparatus 100 may receive printer driver installation information from the agent program. In an embodiment, the image forming apparatus 100 may receive from the agent program whether to install the printer driver of the host device, or may receive the version information of the printer driver installed in the host device.

In operation S430, the image forming apparatus 100 may display the printer driver installation information received from the agent program. In an embodiment, the image forming apparatus 100 may display the installation information of the printer driver received from the agent program in the input/output unit 110. Also, the image forming apparatus 100 may display the received installation information of the printer driver of the host device in a table format.

Further, the image forming apparatus 100 may store the received printer driver installation information.

In operation S440, the image forming apparatus 100 may receive an input from the user to select a host device to install or update the printer driver.

In an embodiment, the image forming apparatus 100 may display a graphical user interface (GUI) for selecting the host device to install the printer driver. The image forming apparatus 100 may display a table for selecting the host device in which the printer driver is to be installed on the input/output unit 110.

For example, the image forming apparatus 100 may determine the host device in which the printer driver is to be installed by receiving a user's touch on the input/output unit 110, or may determine the host device in which the printer driver is to be installed by receiving the external input.

In an embodiment, the image forming apparatus 100 may receive an input for selecting a printer driver to be transmitted. The image forming apparatus 100 may determine the printer driver to be transmitted to the host device according to an external input.

In an embodiment, the image forming apparatus 100 may display a GUI for selecting the printer driver to be transmitted. The image forming apparatus 100 may display a table for selecting the printer driver to be transmitted on the input/output unit 110.

For example, the image forming apparatus 100 may determine a printer driver to be installed by receiving a user's touch on the input/output unit 110, or may determine the printer driver to be installed by receiving an external input.

In operation S450, the image forming apparatus 100 may transmit the printer driver to the selected host device. In an embodiment, the image forming apparatus 100 may transmit a printer driver to a host device in which the printer driver is not installed, or may transmit a printer driver of a different version to a host device in which the printer driver is installed.

The transmitted printer driver may be stored in advance in an internal storage device of the image forming apparatus 100. The transmitted printer driver may be stored in advance in an external storage device or may be stored in advance in a server.

In an embodiment, the image forming apparatus 100 may transmit an installation command of the transmitted printer driver to the agent program. In an embodiment, the image forming apparatus 100 may transmit an install command of the transmitted printer driver to the agent program of the host device selected by the user. Further, the image forming apparatus 100 may transmit a save command or an execution command of the transmitted printer driver to the agent program.

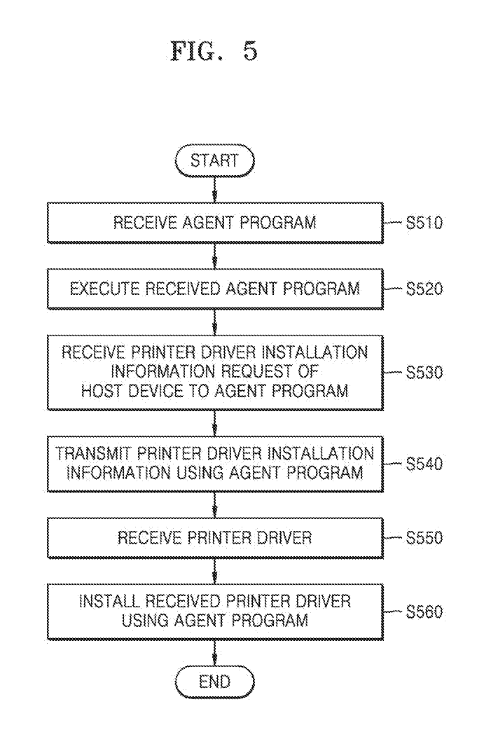

FIG. 5 is a flowchart of a method in which a host device 200 according to an embodiment installs and updates a printer driver by the image forming apparatus 100.

Although there may be a plurality of host devices, for convenience of description, at least one host device 200 will be described below as an example.

In operation S510, the host device 200 may receive an agent program from the image forming apparatus 100.

In operation S520, the host device 200 may execute the received agent program. The host device 200 may store or install the received agent program. The executed agent program may perform an operation related to the printer driver in the host device 200.

In operation S530, the host device 200 may receive a printer driver installation information request to the agent program from the image forming apparatus 100.

In operation S540, the host device 200 may transmit the printer driver installation information to the image forming apparatus 100 using the agent program. The host device 200 may transmit information indicating whether to install the printer driver or may transmit version information of the installed printer driver to the image forming apparatus 100.

In operation S550, the host device 200 may receive the printer driver from the image forming apparatus 100.

In operation S560, the host device 200 may install the received printer driver using the agent program. The host device 200 may store the received printer driver or may execute the printer driver using the agent program.

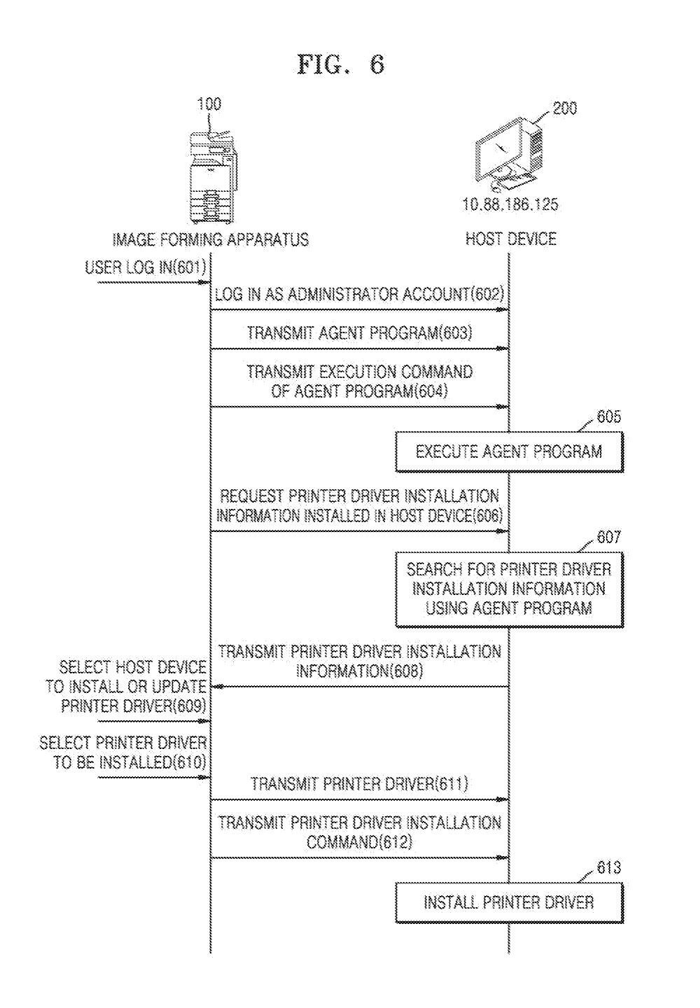

FIG. 6 is a diagram illustrating a process of installing or updating a printer driver according to an embodiment.

Referring to FIG. 6, in operation 601, a user may log in to the image forming apparatus 100. The image forming apparatus 100 may display a GUI for acquiring an identifier (ID) of the user. The image forming apparatus 100 may also receive a touch of the user who inputs the ID and may input an external input for recognizing an identification display (e.g., a bar code) to an identification display recognition apparatus provided in the image forming apparatus 100.

In operation 602, the image forming apparatus 100 may log in as an administrator account to each host device. The administrator account may be defined as an account that has permission to access a device and manage the device. The image forming apparatus 100 logged in as the administrator account may install, execute or store a program on a host device.

In operation 603, the image forming apparatus 100 may transmit an agent program to the host device. Further, in operation 604, the image forming apparatus 100 may transmit an execution command of the agent program transmitted to the host device.

In operation 605, the host device 200 may execute the transmitted agent program. The host device 200 may store or install the agent program.

In operation 606, the image forming apparatus 100 may request printer driver installation information of the host device from the executed agent program.

In operation 607, the host device may search for the printer driver installation information using the agent program. The host device may search for a memory or a control unit to search for whether the printer driver is installed or not and search for version information of the installed printer driver. The agent program may store the found printer driver installation information.

In operation 608, the agent program of the host device may transmit the found printer driver installation information to the image forming apparatus 100. The image forming apparatus 100 may display the transmitted printer driver installation information on a display. Further, the image forming apparatus 100 may store the transmitted printer driver installation information.

In operation 609, the image forming apparatus 100 may receive an input of the user to select a host device to install or update the printer driver. The image forming apparatus 100 may display a GUI for selecting the host device to install or update the printer driver on an input/output unit.

The image forming apparatus 100 may receive a touch input of the user to determine the host device to transmit the printer driver and may receive an external input to determine the host device to transmit the printer driver but is not limited thereto.

In operation 610, the image forming apparatus 100 may receive an input of the user to select a printer driver to be installed. The image forming apparatus 100 may display a GUI for selecting the printer driver to be installed on the input/output unit.

The image forming apparatus 100 may receive a touch input of the user to determine the print driver to be installed and may receive an external input to determine the print driver to be installed.

In operation 611, the image forming apparatus 100 may transmit the selected printer driver to the selected host device. In operation 612, the image forming apparatus 100 may transmit a printer driver installation command to the host device that has received the printer driver.

In operation 613, the host device may install the received printer driver. The host device may store or execute the received printer driver.

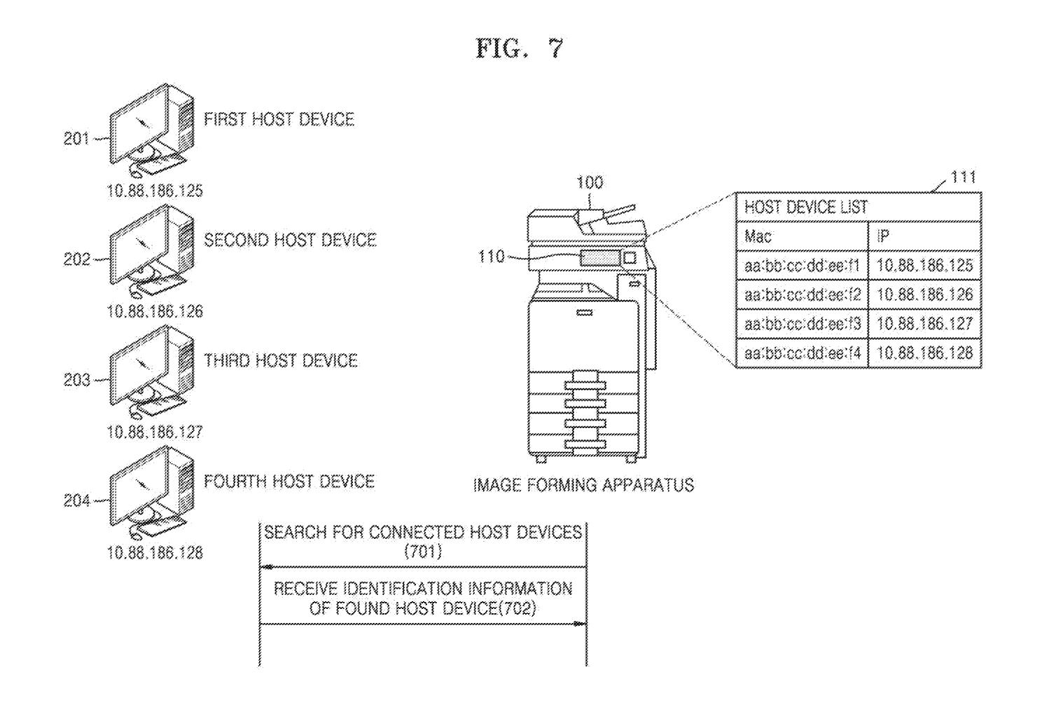

FIG. 7 is a diagram showing an example in which the image forming apparatus 100 searches for a host device according to an embodiment.

Referring to FIG. 7, in operation 701, the image forming apparatus 100 may search for the connected host devices 201 to 204.

In an embodiment, the image forming apparatus 100 and the host devices 201 to 204 may be connected through a network and connected through a server, but are not limited thereto.

In an embodiment, the image forming apparatus 100 may transmit a multicast requesting identification information of the host devices 201 to 204 connected to the network. The identification information of a host device may include at least one of a media access control (MAC) address, an IP address, and an ID of the host device.

In operation 702, the image forming apparatus 100 may receive the identification information of the found host device. In an embodiment, the image forming apparatus 100 may display the received identification information of the host device on the input/output unit 110 and may store the identification information in the memory 140.

In an embodiment, the image forming apparatus 100 may display the received identification information of the host device on the input/output unit 110 in the form of a table. The image forming apparatus 100 may display an MAC address, an IP address, an ID, and the like of the found host device on the input/output unit 110 in a host device list 111.

Referring to FIG. 7, “aa: bb: cc: dd: ee: f1” that is a MAC address of the first host device 201 and “10.88.186.125” that is an IP address thereof may be displayed on a first row of the host device list 111. Further, “aa: bb: cc: dd: ee: f2” that is a MAC address of the second host device 202 and “10.88.186.126” that is an IP address thereof may be displayed in a second row of the host device list 111. Further, “aa: bb: cc: dd: ee: f3” that is a MAC address of the third host device 203 and “10.88.186.127” that is an IP address thereof may be displayed in a third row of the host device list 111. Also, “aa: bb: cc: dd: ee: f4” that is a MAC address of the fourth host device 204 and “10.88.186.128” that is an IP address thereof may be displayed in a fourth row of the host device list 111.

The host device list 111 may include at least one of a MAC address, an IP address, and an ID of a found host device according to a preset configuration, but a display of identification information of the found host device is not limited thereto.

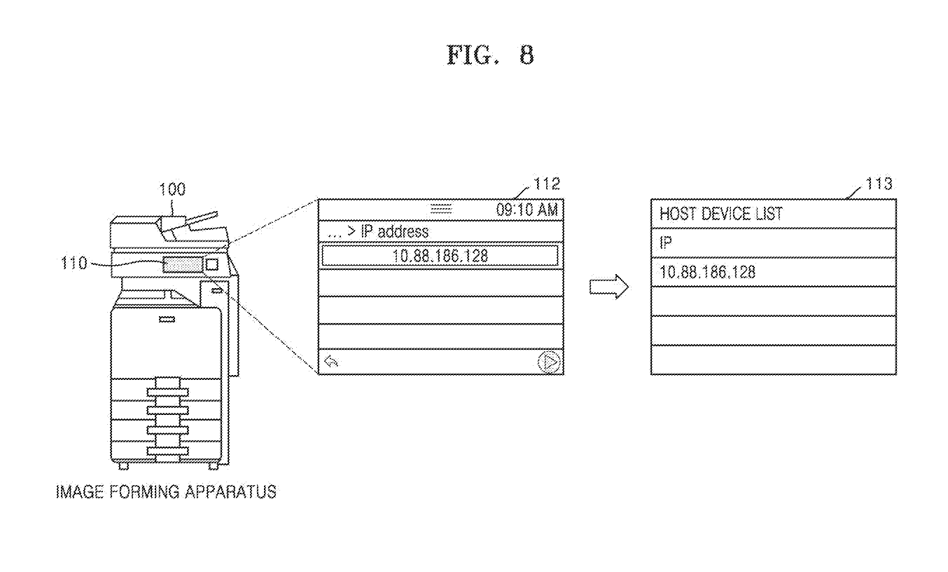

FIG. 8 is a diagram showing an example in which the image forming apparatus 100 according to the embodiment receives identification information of a host device.

Referring to FIG. 8, the image forming apparatus 100 may acquire a connected host device via an input of a user without search. In an embodiment, the image forming apparatus 100 may receive an external input with respect to the identification information of the host device through the input/output unit 110.

The image forming apparatus 100 may display a GUI for inputting the identification information of the host device on the input/output unit 110. In an embodiment, the image forming apparatus 100 may obtain the identification information of the host device from the user through an IP address input window 112. The image forming apparatus 100 may receive “10.88.186.128” that is an IP address through a touch of the user or a button input.

The image forming apparatus 100 may display the identification information of the host device obtained according to the external input on the input/output unit 110. Also, the image forming apparatus 100 may store the identification information of the host device obtained according to the external input in the memory 140.

In an embodiment, the image forming apparatus 100 may display “10.88.186.128” that is the IP address of the host device received from the user in a host device list 113. The host device list 113 may include at least one of a MAC address, an IP address, and an ID of the received host device according to a preset configuration, but a display of identification information of the found host device is not limited thereto.

In an embodiment, the image forming apparatus 100 may merge and display identification information of a found host device and the identification information of the received host device.

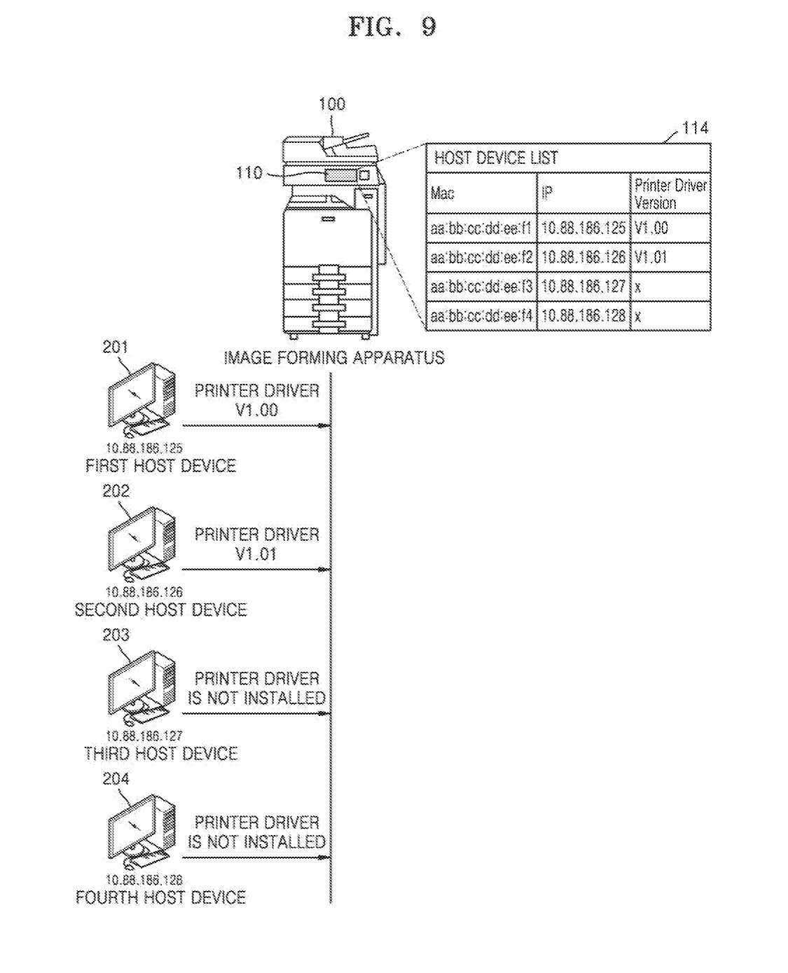

FIG. 9 is a diagram showing an example in which the image forming apparatus 100 according to an embodiment receives printer driver installation information of a host device.

Referring to FIG. 9, the image forming apparatus 100 may acquire printer driver installation information of the host device through an agent program. The image forming apparatus 100 may acquire whether to install the printer driver of the host device or version information of the installed printer driver through the agent program.

The image forming apparatus 100 may display the installation information of the printer driver received from the agent program on the input/output unit 110. Also, the image forming apparatus 100 may store the received installation information of the printer driver in the memory 140.

In an embodiment, the image forming apparatus 100 may display the received installation information of the printer driver of the host device on the input/output unit 110 in the form of a table.

Referring to FIG. 9, for example, “V1.00” that is version information of a printer driver installed in the first host device 201 may be displayed on a first row and a third column of a host device list 114. “V1.01” that is version information of a printer driver installed in the second host device 202 may be displayed in a second row and the third column of the host device list 114. Information indicating that a printer driver is not installed in the third host device 203 and the fourth host device 204 may be displayed on the third column of the host device list 114.

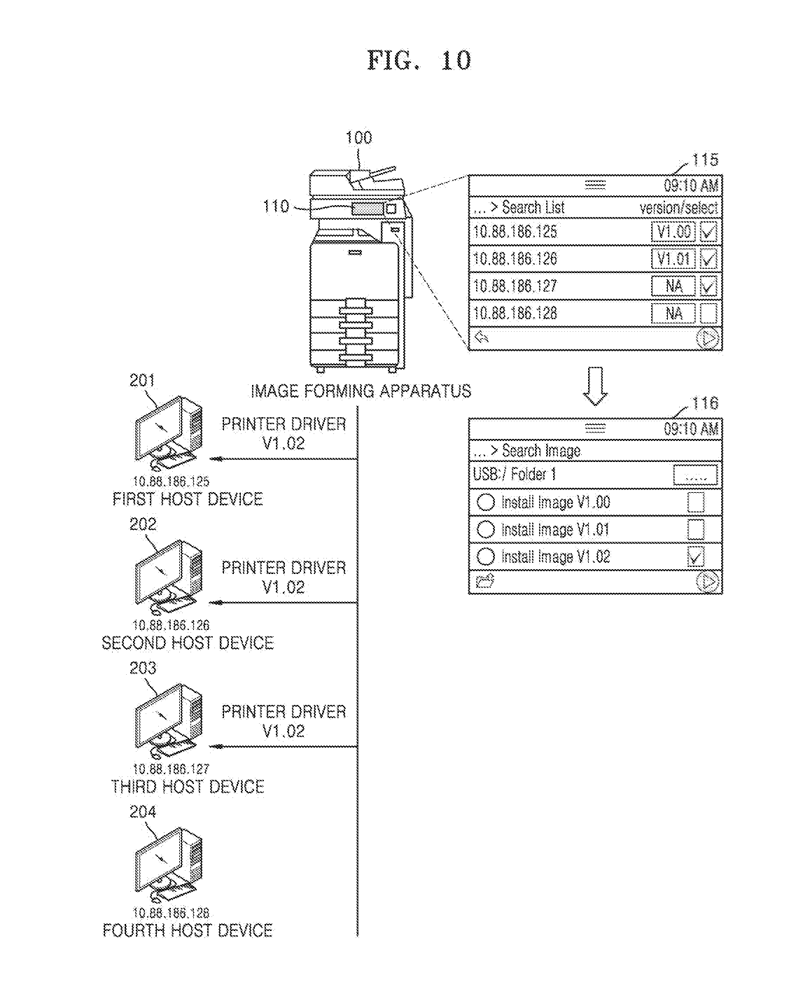

FIG. 10 is a diagram showing an example in the image forming apparatus 100 according to an embodiment installs a printer driver in a selected host device.

In an embodiment, the image forming apparatus 100 may install the printer driver in the host device selected by a user. The image forming apparatus 100 may receive an input of the user who selects the host device to install the printer driver through the input/output unit 110.

In an embodiment, the image forming apparatus 100 may display, on the input/output unit 110, a GUI for selecting a device to install the printer driver. The image forming apparatus 100 may display a host device list 115 for selecting a host device to install the printer driver. Referring to FIG. 10, the image forming apparatus 100 may select the first to third image forming apparatuses 201 to 203 as host devices to transmit the printer driver.

The image forming apparatus 100 may receive an external input for selecting the host device to install the printer driver. Further, the image forming apparatus 100 may receive a touch or a button input of the user selecting the host device. Also, the image forming apparatus 100 may store a received host device list.

In an embodiment, the image forming apparatus 100 may transmit the printer driver selected by the user to the selected host device. The image forming apparatus 100 may receive a user input for selecting a printer driver to be installed.

In an embodiment, the image forming apparatus 100 may display, on the input/output unit 110, a GUI for selecting a printer driver to be installed in the host device. For example, the image forming apparatus 100 may display a printer driver list 116 for selecting the printer driver to be installed.

Referring to FIG. 10, the image forming apparatus 100 may select a printer driver version “V1.02” as the printer driver to be installed in the selected first to third host devices 201 to 203.

The image forming apparatus 100 may receive an external input for selecting a printer driver. Further, the image forming apparatus 100 may receive a touch or a button input of the user selecting the printer driver. Further, the image forming apparatus 100 may store a received printer driver list.

In an embodiment, the image forming apparatus 100 may transmit the selected printer driver to the selected host device. The printer driver may be stored in an external storage device or may be stored in an internal storage device of the image forming apparatus 100. Referring to FIG. 10, the image forming apparatus 100 may transmit the printer driver of the version V 1.02 stored in a first folder Folder 1 of an USB to the first to third host devices 201 to 203.

The agent program of the host device may install the received printer driver in the host device. For example, a printer driver of version V1.00 installed in the first host device 201 and a printer driver of version V1.01 installed in the second host device 202 may be updated to the transmitted printer driver V1.02. The printer driver of version V1.02 may be installed in the third host device 203 in which a printer driver is not installed.

In another embodiment, the image forming apparatus 100 may request printer driver installation information of the host device at a preset date or at a preset time. In this case, the image forming apparatus 100 may request printer driver installation information of a preselected device.

Further, the image forming apparatus 100 may transmit the printer driver to the host device at a preset date or at a preset time. In this case, the image forming apparatus 100 may transmit the printer driver to a preselected host device. The image forming apparatus 100 may transmit a preset printer driver or may transmit a printer driver stored or received most recently in the image forming apparatus 100.

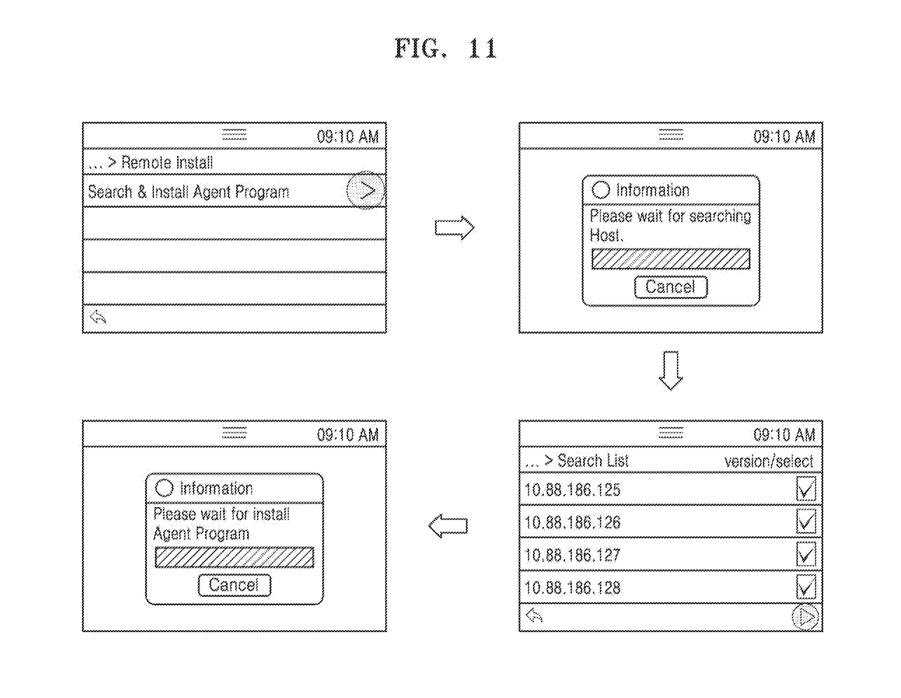

FIG. 11 is a diagram illustrating an example in which the image forming apparatus 100 according to an embodiment selects a host device to install an agent program.

The image forming apparatus 100 may execute or install the agent program on the host device selected according to an external input. In an embodiment, the image forming apparatus 100 may execute or install the agent program on a host device selected by a user.

The image forming apparatus 100 may search for connected host devices. The image forming apparatus 100 may display a found host device list.

Further, the image forming apparatus 100 may receive an external input for selecting the host device to install the agent program. The image forming apparatus 100 may execute or install the agent program only on the selected host device.

The image forming apparatus 100 may control an operation related to the printer driver only by host devices that have executed the agent program.

The afore-described embodiments may also be embodied as a non-transitory computer-readable recording medium having recorded thereon computer-executable instructions and data. At least one of the instructions and data may be stored in the form of program code, and may configure a program module to perform an appropriate operation when executed by a processor.

Examples of the non-transitory computer-readable recording medium include magnetic storage media (e.g., hard disks) and optical recording media (e.g., CDs or DVDs), or memories included in a server accessible through a network. For example, the non-transitory computer-readable recording medium may include at least one of the memory 140 of the image forming apparatus 100 and a memory of the input and output unit 110, or include the memory 240 of the mobile device 200 connected to the image forming apparatus 100 through a network.

Printer drivers may be collectively installed in a plurality of computers and the printer drivers installed in the computers may be easily managed.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method, performed by an image forming apparatus, of installing a printer driver in at least one host device, the method comprising:
transmitting an agent program to a host device;
receiving printer driver installation information of the host device from the transmitted agent program;
displaying the received printer driver installation information on the image forming apparatus;
receiving, from a user, an input of selecting, from the displayed printer driver installation information, the at least one host device in which to install or update the printer driver; and
transmitting the printer driver to the selected host device so that the printer driver is installed in the selected at least one host device.

2. The method of claim 1, wherein the transmitting of the agent program to the host device comprises:
searching for the host device connected to the image forming apparatus; and
receiving identification information of the host device found by the searching.

3. The method of claim 1, wherein the transmitting of the agent program to the host device comprises receiving identification information of the host device from the user.

4. The method of claim 1, wherein the transmitting of the agent program to the host device comprises receiving, from the user, an input of selecting the host device to which to transmit the agent program.

5. The method of claim 1, wherein the printer driver installation information comprises information indicating whether to install the printer driver or version information of the printer driver.

6. The method of claim 1, wherein the printer driver is acquired from an external storage device or an internal storage device of the image forming apparatus.

7. The method of claim 1, wherein the printer driver is a printer driver of a version selected by the user.

8. The method of claim 1, wherein the transmitting of the printer driver to the selected at least one host device comprises transmitting an installation command of the transmitted printer driver to the selected at least one host device.

9. An image forming apparatus comprising:
an interface configured to receive an input from a user and display printer driver installation information;
a communicator configured to transmit data to a host device; and
a controller configured to receive an input of selecting, from the displayed printer driver installation information, at least one host device in which to install or update a printer driver from the user through the interface, transmit an agent program to the selected at least one host device through the communicator, receive the printer driver installation information of the at least one host device from the transmitted agent program, and transmit the printer driver to the at least one host device so that the printer driver is installed in the at least one host device.

10. The image forming apparatus of claim 9, wherein the controller is further configured to search for the at least one host device connected to the image forming apparatus and receive identification information of a found host device through the communicator.

11. The image forming apparatus of claim 9, wherein the controller is further configured to receive identification information of the at least one host device from the user through the communicator.

12. The image forming apparatus of claim 9, wherein the controller is further configured to receive an input of selecting the at least one host device to which to transmit the agent program from the user through the interface.

13. The image forming apparatus of claim 9, wherein the printer driver installation information comprises information indicating whether to install the printer driver or version information of the printer driver.

14. The image forming apparatus of claim 9, wherein the printer driver is acquired from an external storage device or an internal storage device of the image forming apparatus.

15. The image forming apparatus of claim 9, wherein the printer driver is a printer driver of a version selected by the user.

16. The image forming apparatus of claim 9, wherein the controller is further configured to transmit an installation command of the transmitted printer driver to the selected host device through the communicator.

17. A non-transitory computer-readable recording medium having recorded thereon a program for executing the method of claim 1, by using a computer.
